(19) United States
(12) Patent Application Publication
(10) Pub. No.: US 2015/0090291 A1
(43) Pub. Date: Apr. 2, 2015

(54) APPARATUS AND METHOD FOR REMOVING CONTAMINATION FROM DISTANCE MEASURING SENSOR FOR VEHICLE

(71) Applicant: Electronics and Telecommunications Research Institute, Daejeon (KR)

(72) Inventors: Ki In NA, Daejeon (KR); Jaemin BYUN, Daejeon (KR); Myung Chan ROH, Daejeon (KR); Beom-Su SEO, Daejeon (KR); Sung Hoon KIM, Daejeon (KR)

(73) Assignee: Electronics and Telecommunications Research Institute, Daejeon (KR)

(21) Appl. No.: 14/223,430

(22) Filed: Mar. 24, 2014

(30) Foreign Application Priority Data
Sep. 27, 2013 (KR) 10-2013-0115486

(51) Int. Cl. B60S 1/08; B60S 1/52; B60S 1/56

(52) U.S. Cl. CPC B60S 1/0822; B60S 1/56; B60S 1/52
USPC 134/6; 15/250.12

(57) ABSTRACT

An apparatus for removing contamination for use with a distance measuring sensor, the apparatus comprising: a distance measuring module mounted inside or outside of a vehicle and configured to measure the distance between the vehicle and objects around the vehicle; a distance-based recognition unit configured to recognize a surround environment of the vehicle based on the distance measured by the distance measuring module; and a contamination removing module configured to measure the level of contamination on the distance measuring module and perform a cleaning with respect to an area where the contamination occurs when the measured level of contamination is above a preset threshold.

### RELATED APPLICATIONS

This application claims priority to and the benefit of Korean Patent Application No. 10-2013-0115486, filed on Sep. 27, 2013, which is hereby incorporated by reference in its entirety.

### FIELD OF THE INVENTION

The present invention relates to a distance measuring sensor for use in a motor vehicle, and more particularly, to an apparatus and method for removing contamination from a distance measuring sensor for a motor vehicle that are capable of periodically measuring contamination level on the front surface of the distance measuring sensor such as a LIDAR sensor, RADAR sensor or the like installed inside or outside the vehicle and performing a cleaning with respect to an area of the front surface where contamination occurs using a contamination removing apparatus comprised of a windshield wiper or washer liquid dispenser when the measured contamination level is above a preset threshold, thereby effectively removing the contamination from the distance measuring sensor for a vehicle.

### BACKGROUND OF THE INVENTION

Currently, ADASs (Advanced Driver Assistance Systems) have been mainly launched in combination of an image device in market. However, since traveling information obtainable from image information only is confined, an apparatus that combines a RADAR sensor is being launched in recent years.

An ultrasonic sensor on the front surface of a motor vehicle is used to inform a driver of distance information useful to prevent collision when parking. A LIDAR sensor that is relatively expensive is not widely used but its usage increases because of relatively correct sensing information and robust to environmental change. As such, these distance measuring sensors are mainly used as a sensor to assist the driving of the vehicle.

However, when the front surface of a distance measuring sensor is contaminated with dirt, dust or others during the driving a vehicle, the distance measuring sensor may cause error or output sensing value to incorrectly recognize the contamination as proximate obstacle.

As set forth above, in case where contamination occurs in the front surface of the distance measuring sensor, related inventions or techniques up to date typically recognizes the contamination through an image and activates a windscreen wiper to remove the contamination.

However, the related arts described above are applied to the ADAS based on a camera that can be installed inside of the vehicle only to clean contamination on a windshield glass for a vehicle, but are hard to apply to a distance measuring sensor that is mainly installed outside the vehicle and is difficult to get rid of the contamination with a windscreen wiper.

### SUMMARY OF THE INVENTION

In view of the above, the present invention provides an apparatus and method for removing contamination from a distance measuring sensor used in a motor vehicle that are capable of periodically measuring a contamination level on the front surface of the distance measuring sensor such as a LIDAR sensor, RADAR sensor or the like installed inside or outside the vehicle and performing a cleaning with respect to an area of the front surface where the contamination occurs using the contamination removing apparatus comprised of a windshield wiper or washer liquid dispenser when the measured contamination level is above a preset threshold, thereby effectively removing the contamination from the distance measuring sensor for a vehicle.

In accordance with an embodiment of the present invention, there is provided an apparatus for removing contamination for use with a distance measuring sensor, the apparatus comprising: a distance measuring module mounted inside or outside of a vehicle and configured to measure the distance between the vehicle and objects around the vehicle; a distance-based recognition unit configured to recognize a surround environment of the vehicle based on the distance measured by the distance measuring module; and a contamination removing module configured to measure the level of contamination on the distance measuring module and perform a cleaning with respect to an area where the contamination occurs when the measured level of contamination is above a preset threshold.

In the embodiment, the distance measuring module comprises: a distance measuring sensor configured to generate a sensing signal for measuring the distance between the vehicle and the respective peripheral objects; and a distance measuring unit configured to measure the distance between the vehicle and the respective peripheral objects.

In the embodiment, the distance measuring sensor comprises a LIDAR sensor or a RADAR sensor.

In the embodiment, the contamination removing module comprises: a contamination measuring unit configured to measure the level of contamination occurred in a predetermined area on a front surface of the distance measuring sensor; and a cleaning unit configured to perform a cleaning with respect to the area when the measured level of contamination is above a preset threshold.

In the embodiment, the cleaning unit comprises: a wiper configured to clean the area; and a washer liquid dispenser configured to spray washer liquid over the area.

In accordance with an embodiment of the present invention, there is provided a method for removing contamination from a distance measuring sensor, the apparatus comprising: measuring the distance between a vehicle and objects peripheral to the vehicle using a distance measuring sensor; recognizing a surround environment of the vehicle based on the measured distance; and measuring the level of contamination on the distance measuring sensor; and performing a cleaning with respect to an area where the contamination occurs when the measured level of contamination is above a preset threshold.

In the embodiment, said measuring the distance comprises: receiving a sensing signal for measuring the distance between the vehicle and the respective peripheral objects from the distance measuring sensor; and measuring the distance between the vehicle and the respective peripheral objects using the sensing signal received from the distance measuring sensor.

In the embodiment, the distance measuring sensor comprises a LIDAR sensor or a RADAR sensor.

In the embodiment, said performing a cleaning the area comprises: spraying washer liquid over the area where the contamination occurs on the front surface of the distance measuring sensor; and performing a cleaning with respect to the area over which the washer liquid is sprayed using a wiper.

With the contamination removing apparatus configured above, it is possible to effectively remove the contamination on the distance measuring sensor by periodically measuring the contamination level with respect to the front surface of the distance measuring sensor such as a LIDAR sensor, RADAR sensor, etc. for a vehicle installed inside or outside the vehicle and performing a cleaning with respect to an area of the front surface where contamination occurs using the contamination removing module comprised of the windshield wiper and/or the wisher liquid dispenser when the measured contamination level is above the preset threshold.

Further, when the front surface of the distance measuring sensor is contaminated, a solution to remove the contamination is provided, and thus it is possible to employ the distance measuring sensor (e.g., the LIDAR, RADAR, etc.) as a recognition sensor necessary for driving even in an environment where the distance measuring sensor of which usage is increasing as the ADAS is likely to be easily contaminated.

### BRIEF DESCRIPTION OF THE DRAWINGS

The above and other objects and features of the present invention will become apparent from the following description of the embodiments given in conjunction with the accompanying drawings, in which:

FIG. 1 is a block diagram of an apparatus for removing contamination from a distance measuring sensor for a motor vehicle in accordance with an embodiment of the present invention;

FIG. 2 is a detailed block diagram of a distance measuring sensor module in accordance with an embodiment of the present invention;

FIG. 3 is a detailed block diagram of a contamination removing module in accordance with an embodiment of the present invention;

FIG. 4 is a flowchart of a contamination removing process performed by the distance measuring sensor for a motor vehicle in accordance with an embodiment of the present invention;

FIG. 5 is a conceptual diagram of how to remove contamination in case where a distance measuring sensor is installed inside a motor vehicle; and

FIG. 6 is a conceptual diagram of how to remove contamination in case where a distance measuring sensor is installed outside a motor vehicle.

### DETAILED DESCRIPTION OF THE EMBODIMENTS

Hereinafter, the embodiments of the present invention will be described in detail with reference to the accompanying drawings. In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may be made on a basis of the content throughout the specification.

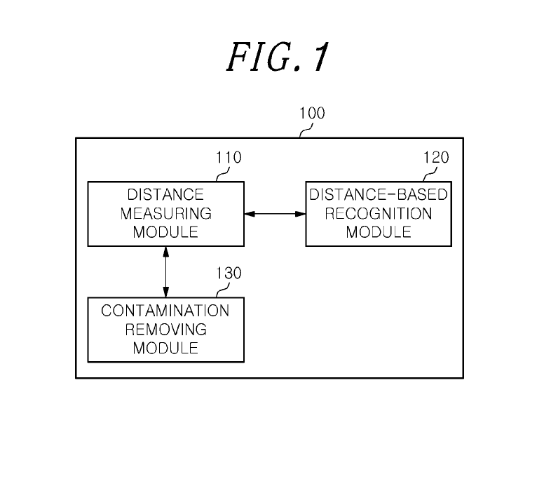

FIG. 1 is a block diagram of an apparatus for removing contamination from a distance measuring sensor for a motor vehicle in accordance with an embodiment of the present invention. A contamination removing apparatus 100 includes a distance measuring module 110, a distance-based recognition module 120 and a contamination removing module 130.

Hereinafter, the operation of the respective components of the contamination removing apparatus 100 for used in a distance measurement sensor for a vehicle will be described with reference to FIG. 1.

The distance measuring module 110 is installed inside or outside a motor vehicle and measures the distance between the vehicle and objects located around the vehicle.

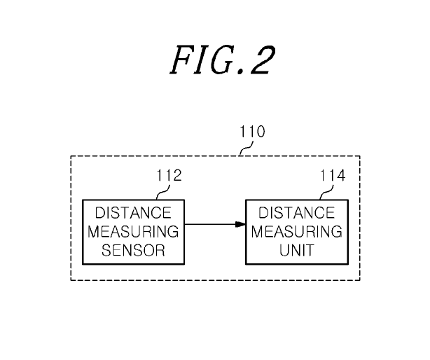

Such a distance measuring module 110 includes a distance measuring sensor 112 and a distance measuring unit 114, as shown in FIG. 2.

The distance measuring sensor 112 may be implemented by a LIDAR or RADAR or the like and produces a sensing signal for measuring the distance between the vehicle and its peripheral objects. The distance measuring unit 114 measures the distance between the vehicle and its peripheral objects using the sensing signal provided from the distance measuring sensor 112.

The distance-based recognition module 120 recognizes the surrounding environment of the vehicle using distance information measured through the distance measuring module 110.

When the level of contamination measured by the distance measuring module 110 is above a preset threshold, the contamination removing module 130 performs a cleaning of a relevant area where the contamination occurs.

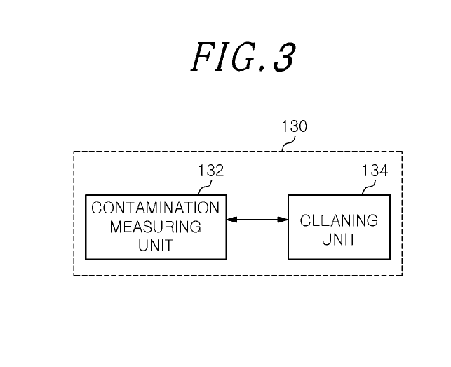

The contamination removing module 130 includes the contamination measuring unit 132 and the cleaning unit 134, as shown in FIG. 3.

The contamination measuring unit 132 measures the level of contamination occurred in a specific area on a front surface of the distance measuring sensor 112. The cleaning unit 134 performs a cleaning with respect to the area where the contamination occurs when the level of the contamination measured by the contamination measurement unit 132 is above a preset threshold.

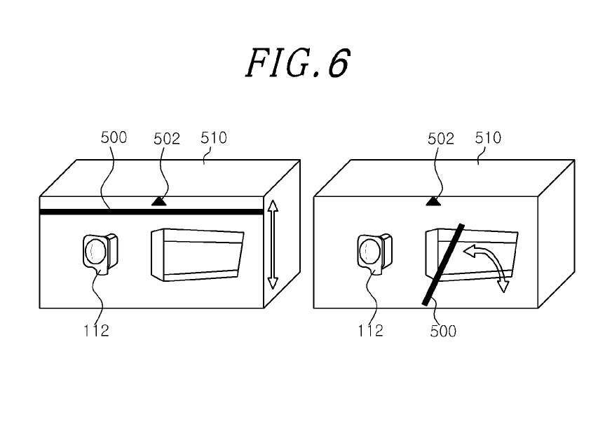

The cleaning unit 134 includes, for example, a windshield wiper 500 and a washer fluid dispenser 502, which will be discussed with reference to FIG. 6 later. The washer fluid dispenser 502 sprays washer liquid for contamination removal from the area on the front surface of the distance measuring sensor 112 where contamination occurs, and the windshield wiper 500 wipes off the washer liquid sprayed on the point of the contaminated area while moving in left and right directions or up and down directions movement location.

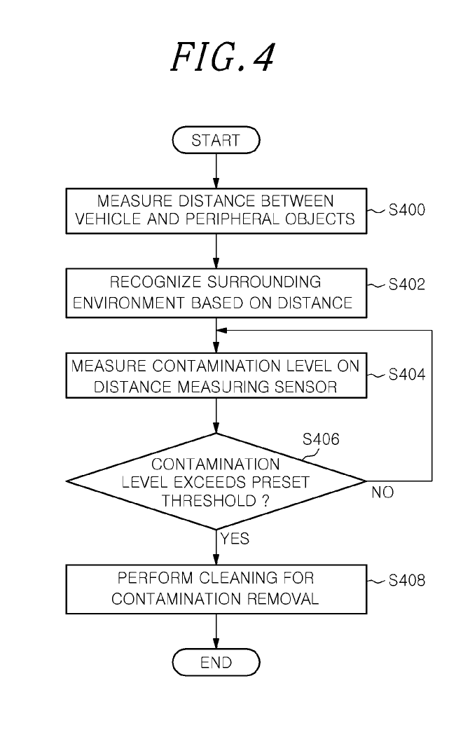

FIG. 4 is a flowchart of a contamination removing process performed by the distance measuring sensor for a motor vehicle in accordance with an embodiment of the present invention. Hereinafter, the embodiment of the present invention will be described with reference to FIGS. 1 to 4.

First, the contamination removing apparatus 100 used in the distance measurement sensor for a motor vehicle measures the distance between the vehicle and objects around the vehicle through the use of the distance measuring sensor 112 mounted on inside or outside the vehicle in block 5400.

Next, the contamination removing apparatus 100 recognizes the surrounding environment of the vehicle on a distance basis using the distance measured through the distance measuring sensor 112 in block 5402.

Subsequently, the contamination removing apparatus 100 measures the level of contamination of the distance measuring sensor 112 on a regular basis in block 5404 and checks whether the level of the measured contamination exceeds a preset threshold in block 5406.

When it is checked that the level of the measured contamination exceeds a preset threshold, the contamination removing apparatus 100 removes the contamination occurred on the distance measuring sensor 112 in block 5408.

For example, when there occurs the contamination such as the attachment of foreign materials on an area which may effect on signals that are transmitted and received by the distance measuring sensor 112, the contamination removing apparatus 100 forces the contamination removing module 130 to remove the relevant contamination.

In the operation of removing the contamination process, for example, the contamination removing apparatus 100 sprays the washer liquid for the contamination removal over the contaminated area and activates the windshield wiper or the like in up and down directions or left and right directions to clean the contaminated area over which the washer liquid is sprayed.

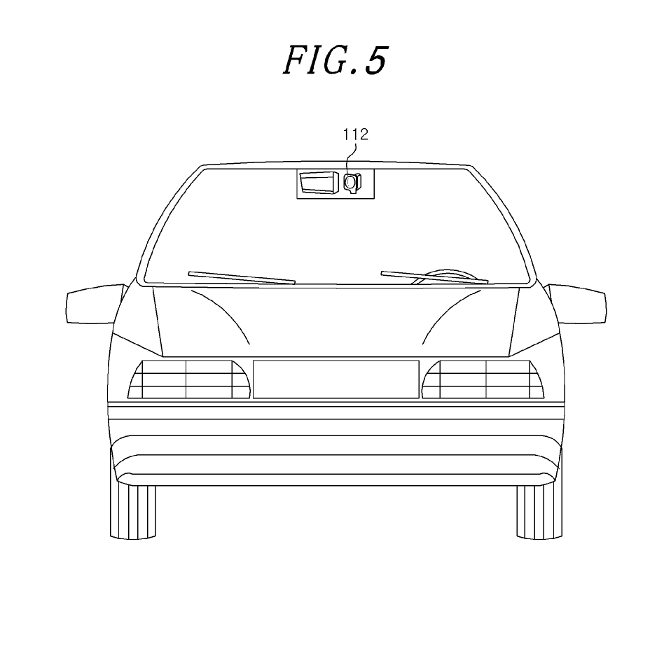

FIG. 5 is a conceptual diagram of how to remove the contamination in case where the distance measuring sensor is installed inside the vehicle.

Referring to FIG. 5, in the case where the distance measuring sensor is installed inside the vehicle, the contamination may be removed by use of the windshield wiper when it occurs on a front glass on which the distance measuring sensor 112 is arranged.

In such a case, it is preferred that the front glass is made of a material through which light or sound can be transmitted without scattering or deflecting so that the distance measuring sensor 112 arranged inside the vehicle performs behind the front glass. It is because that regular glass can allow light or sound to transmit it but cause diffusion or attenuation of the light or sound. Thus, if it is detected that the contamination occurs on the front glass on which the distance measuring sensor 112 is arranged, the windshield wiper is activated until the contamination can be removed while spraying the washer liquid. According to the present invention, however, during the activation of the windshield wiper, the contamination removing apparatus 100 is designed not to recognize the windshield wiper as the contamination by way of a filtering technique.

FIG. 6 is a conceptual diagram of how to remove the contamination in case where a distance measuring sensor is installed outside the vehicle.

Referring to FIG. 6, in the case where a distance measuring sensor 112 is installed outside the vehicle, the distance measuring sensor 112 is disposed inside a housing 510 whose front surface is made of a material with transmissive property suitable for the distance measuring sensor. A windshield wiper 500 for the contamination removal is mounted on the front surface of the housing. When the contamination is detected, the washer liquid is sprayed from the washer fluid dispenser 502 and the windshield wiper 500 is activated to remove the relevant contamination. In this regard, the movement of the windshield wiper 500 and the location of the washer fluid dispenser 502 may be varied as needed.

As described above, with the contamination removing apparatus configured above, it is possible to effectively remove the contamination on the distance measuring sensor for a vehicle by periodically measuring the contamination level with respect to the front surface of the distance measuring sensor such as the LIDAR sensor, RADAR sensor, etc. installed inside or outside the vehicle and performing a cleaning task with respect to the area of the front surface where the contamination occurs using the contamination removing apparatus comprised of the windshield wiper and/or the washer liquid dispenser when the measured contamination level is above the preset threshold.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for removing contamination for use with a distance measuring sensor, the apparatus comprising:
a distance measuring module mounted inside or outside of a vehicle and configured to measure the distance between the vehicle and objects around the vehicle;
a distance-based recognition unit configured to recognize a surround environment of the vehicle based on the distance measured by the distance measuring module; and
a contamination removing module configured to measure the level of contamination on the distance measuring module and perform a cleaning with respect to an area where the contamination occurs when the measured level of contamination is above a preset threshold.

2. The apparatus of claim 1, wherein the distance measuring module comprises:
a distance measuring sensor configured to generate a sensing signal for measuring the distance between the vehicle and the respective peripheral objects; and
a distance measuring unit configured to measure the distance between the vehicle and the respective peripheral objects.

3. The apparatus of claim 2, wherein the distance measuring sensor comprises a LIDAR sensor or a RADAR sensor.

4. The apparatus of claim 1, wherein the contamination removing module comprises:
a contamination measuring unit configured to measure the level of contamination occurred in a predetermined area on a front surface of the distance measuring sensor; and
a cleaning unit configured to perform a cleaning with respect to the area when the measured level of contamination is above a preset threshold.

5. The apparatus of claim 4, wherein the cleaning unit comprises:
a wiper configured to clean the area; and
a washer liquid dispenser configured to spray washer liquid over the area.

6. A method for removing contamination from a distance measuring sensor, the apparatus comprising:
measuring the distance between a vehicle and objects peripheral to the vehicle using a distance measuring sensor;
recognizing a surround environment of the vehicle based on the measured distance; and
measuring the level of contamination on the distance measuring sensor; and
performing a cleaning with respect to an area where the contamination occurs when the measured level of contamination is above a preset threshold.

7. The method of claim 6, wherein said measuring the distance comprises:
receiving a sensing signal for measuring the distance between the vehicle and the respective peripheral objects from the distance measuring sensor; and
measuring the distance between the vehicle and the respective peripheral objects using the sensing signal received from the distance measuring sensor.

8. The method of claim 6, wherein the distance measuring sensor comprises a LIDAR sensor or a RADAR sensor.

9. The method of claim 6, wherein said performing a cleaning the area comprises:
spraying washer liquid over the area where the contamination occurs on the front surface of the distance measuring sensor; and
performing a cleaning with respect to the area over which the washer liquid is sprayed using a wiper.
